(19) United States
(12) Patent Application Publication
(10) Pub. No.: US 2004/0261275 A1
(43) Pub. Date: Dec. 30, 2004

(54) Sharpener for creating a frusto-conical tip

(75) Inventors: Gerald Paul Fregeolle, Statesville, NC (US); Wing Fai Wong, Hong Kong (CN)

Correspondence Address: SYNNESTVEDT & LECHNER, LLP, 2600 ARAMARK TOWER, 1101 MARKET STREET, PHILADELPHIA, PA, 191072950

(73) Assignee: Hunt Holdings, Inc., Wilmington, DE

(21) Appl. No.: 10/654,079

(22) Filed: Sep. 3, 2003

Related U.S. Application Data
(60) Provisional application No. 60/483,578, filed on Jun. 27, 2003.

(51) Int. Cl. B43L 23/00

(52) U.S. Cl. 30/457

(57) ABSTRACT

A razor-blade type sharpener for sharpening a writing instrument to provide a frusto-conical tip. The sharpener has a blade carrier that includes a first cutting blade for sharpening the writing instrument to provide a longitudinally tapered portion, and a second cutting blade having a cutting edge extending transversely to the first cutting blade for cutting a distal end of the writing instrument to provide a blunt end portion. Accordingly, the blade carrier is capable of providing a frusto-conical tip having a broad point on a writing instrument, which has been found particularly desirable for crayons. A container for a writing instrument, each including such a blade carrier, are also provided.

### CROSS-REFERENCE TO RELATED APPLICATION

This application claims the benefit of U.S. Provisional Patent Application No. 60/483,578, filed Jun. 27, 2003, the entire disclosure of which is hereby incorporated herein by reference.

### FIELD OF THE INVENTION

The present invention relates generally to a sharpener for crayons, lead pencils, colored pencils, cosmetic pencils and the like, and more particularly to a razor-blade type sharpener.

### DISCUSSION OF RELATED ART

Unlike some sharpeners of the prior art that include a complex arrangement of one or more rotating cutters having spiral cutting edges and the like, razor-blade type sharpeners are relatively simple and include a substantially straight razor-type blade that is fixed to a blade carrier. The blade carrier includes an insertion bore for receiving a writing instrument such as a pencil, crayon, or the like, which is inserted into the bore. The sharpener is typically held stationary while the writing instrument is rotated within the sharpener, the edge of the blade cutting material from the writing instrument to form a point. Exemplary manual razor-blade type sharpeners are disclosed in U.S. Pat. Nos. 4,248,283 and 5,167,071, the entire disclosures of which are hereby incorporated herein by reference.

Powered razor-blade type sharpeners are also known in the art. Exemplary powered razor-blade type sharpeners are disclosed in U.S. Pat. No. 4,050,487, U.S. Pat. No. Des. 320,812 and U.S. Pat. No. Des. 354,987, the entire disclosures of which are hereby incorporated herein by reference. An exemplary battery powered razor-blade type pencil sharpener is manufactured and/or distributed by Hunt Corporation of Philadelphia, Pa., U.S.A. under the trademark as Boston® Buzz™ (item number 16758). Such powered sharpeners cause a blade carrier to rotate relative to a writing instrument that has been inserted into the blade carrier and held stationary to sharpen the writing instrument.

Sharpeners are known in various configurations for sharpening pencils, crayons, cosmetic pencils, etc. Generally, the size of the sharpener/blade carrier, the inclination angle of the blade, and the size of the entry and outlet openings of the blade carrier insertion bore depend upon the type of writing instrument to be sharpened, e.g. a hard lead pencil, a soft lead pencil, a relatively soft crayon, or a relatively soft cosmetic pencil, as generally known in the art.

The blade carriers of many sharpeners, particularly those of pencil sharpeners, are designed to sharpen the writing instrument to a very fine, sharp conical point or tip. FIGS. 1 and 2 show an exemplary blade carrier 10 including a razor-type blade 12 mounted by a bolt, screw or other fastener inserted through-hole 13. The blade 12 has a sharp edge 14 for sharpening a writing instrument 100 received through an insertion bore 16 of the blade carrier 10, as shown in FIGS. 1 and 2. The insertion bore 16 is tapered between a broad outer end 17 and a narrower inner end 19, and allows an end of a writing instrument 100 to be inserted into the blade carrier 10 such that it will be sharpened by the blade 12 when the pencil is rotated relative to, and moves into, the blade carrier 10. In particular, the insertion bore 16 serves as a guide and/or brace to push and/or support the writing instrument 100 against the blade 12 for sharpening.

Such blade carriers often include a flat stop surface 20 adjacent the inner end 19 of the insertion bore 16 against which the sharpened point 102 of the conical tip 104 abuts when the writing instrument 100 is fully sharpened. Accordingly, when the writing instrument 100 has proceeded to a point abutting the stop surface 20, further rotation of the writing instrument or blade carrier will not cause further inward movement thereof. In this manner, no additional writing instrument material will be cut away, thereby preventing oversharpening and the corresponding waste of the writing instrument.

It is sometimes desirable to have a relatively broad, blunt point, rather than a very fine, sharp conical point. Some blade carriers and/or sharpeners have been provided for creating a blunt point. See U.S. Pat. No. 5,802,948 to Andrisin (ejector pin forward end surface 275, col. 12, lines 35-47) and U.S. Pat. No. 4,248,283 to Kaye (flat edge 54—col. 5, lines 21-30). However, such blade carriers and/or sharpeners have been found ineffective and/or inefficient for providing a desired blunt tip, particularly for a crayon, for which it is advantageous to provide a frusto-conical tip. Such a tip is highly desirable because the relatively soft crayon wax does not readily hold a sharp point.

### SUMMARY

The present invention provides a razor-blade type blade carrier for sharpening a writing instrument to provide a frusto-conical tip. The blade carrier includes a first cutting blade for sharpening the writing instrument to provide a longitudinally tapered end portion, and a second cutting blade having a cutting edge extending transversely to the first cutting blade for cutting a distal end of the writing instrument to provide a blunt end portion. In this manner, the blade carrier is capable of creating a generally frusto-conical (truncated cone-shaped) tip on the writing instrument. More particularly, the blade carrier includes a body having an insertion bore. The insertion bore has a longitudinal axis and is adapted to receive a writing instrument. The first cutting blade is supported on the body in operative position with respect to the insertion bore for tapering the writing instrument in the longitudinal direction of the insertion bore. The second cutting blade is supported on the body and is operatively positioned with respect to the insertion bore for cutting the writing instrument in a direction transverse to the longitudinal direction of the insertion bore, e.g. perpendicularly thereto. The second blade's cutting edge is preferably positioned to intersect the longitudinal axis of the insertion bore.

Accordingly, the blade carrier is capable of providing a frusto-conical tip on a writing instrument, which has been found particularly desirable for crayons. In a certain embodiment, the blade carrier cuts an undercut into the writing instrument adjacent the frusto-conical tip, which provides an appearance similar to that of a new crayon.

A sharpener and a container for a writing instrument, each including such a blade carrier, are also provided.

### BRIEF DESCRIPTION OF THE DRAWINGS

The present invention will now be described by way of example with reference to the following drawings in which:

FIG. 1 is a plan view of a razor-blade type blade carrier that is exemplary of the prior art;

FIG. 2 is a cross-sectional view of the blade carrier of FIG. 1, taken along line 2-2 of FIG. 1;

FIG. 3 is a plan view of an exemplary razor-blade type blade carrier in accordance with the present invention;

FIG. 4 is a cross-sectional view of the blade carrier of FIG. 3, taken along line 4-4 of FIG. 3;

FIGS. 5A and 5B are cross-sections views of the blade carrier of FIG. 3, taken along line 5A,5B of FIG. 3;

FIG. 6 is a plan view of an exemplary razor-blade type blade carrier in accordance with an alternative embodiment of the present invention;

FIG. 6A is a cross-sectional view of the blade carrier of FIG. 6, taken along line 6A-6A of FIG. 6;

FIG. 7 is a cross-sectional view of the blade carrier of FIG. 6, taken along line 7-7 of FIG. 6;

FIG. 8 is a perspective view of an exemplary sharpener in accordance with the present invention; and

FIG. 9 is a perspective view of a writing instrument container in accordance with the present invention.

### DETAILED DESCRIPTION

The present invention provides a blade carrier and sharpener generally similar in configuration to a conventional razor-blade type blade carrier and sharpener. However, in addition to the razor-blade for sharpening a writing instrument to provide a generally conical tip, the blade carrier of the present invention further includes an additional blade having a cutting edge extending transversely to the cutting edge of the razor-blade for cutting a distal end of the writing instrument. In this manner, a writing instrument is sharpened by the blade carrier both longitudinally (to provide a tapered, generally conical tip) and transversely (to provide a broad point at the writing instrument's distal end). Accordingly, the blade carrier provides a frusto-conical tip on a writing instrument, which is particularly desirable for crayons.

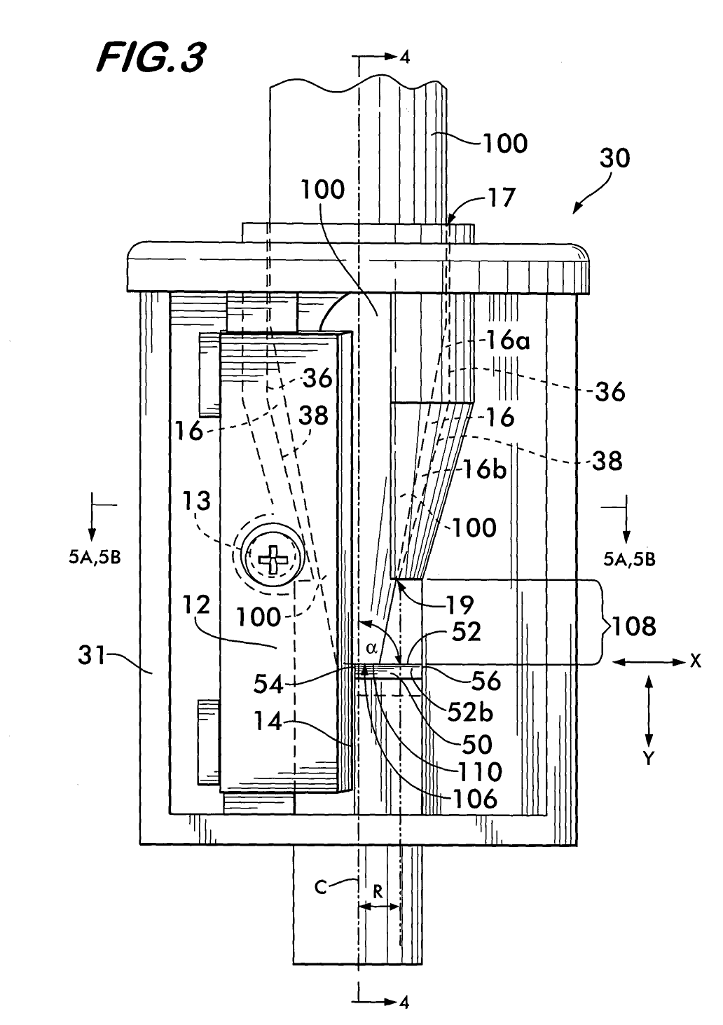

FIGS. 3, 4, 5A and 5B show a blade carrier 30 according to the present invention. The blade carrier 30 is suitable for use as, or for inclusion in, a manual, conventional sharpener in which the blade carrier 30 is held stationary and the writing instrument is manually rotated relative thereto for sharpening.

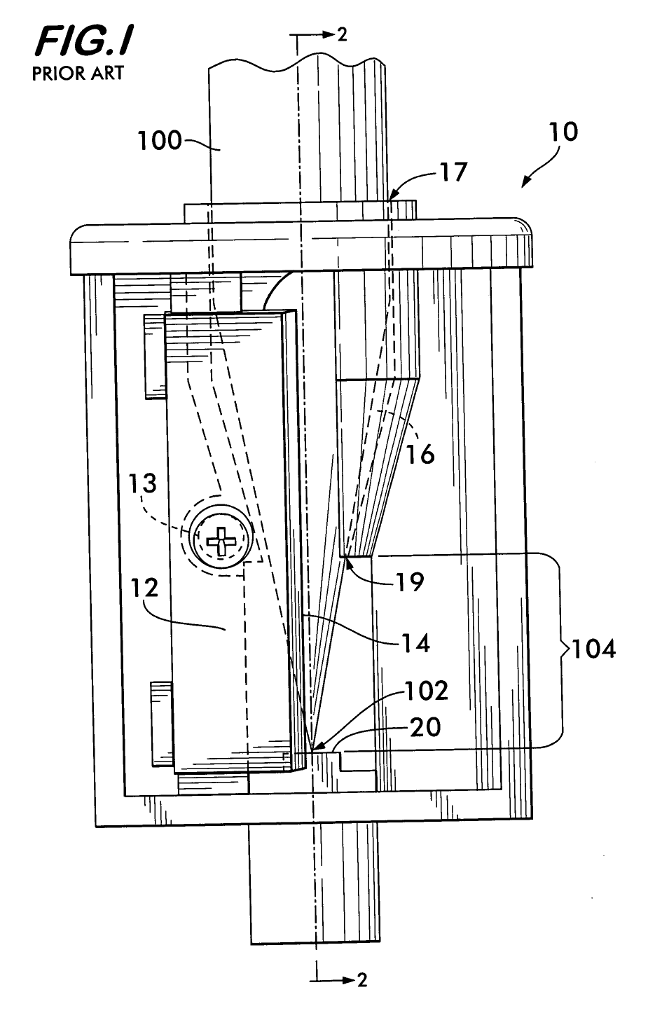

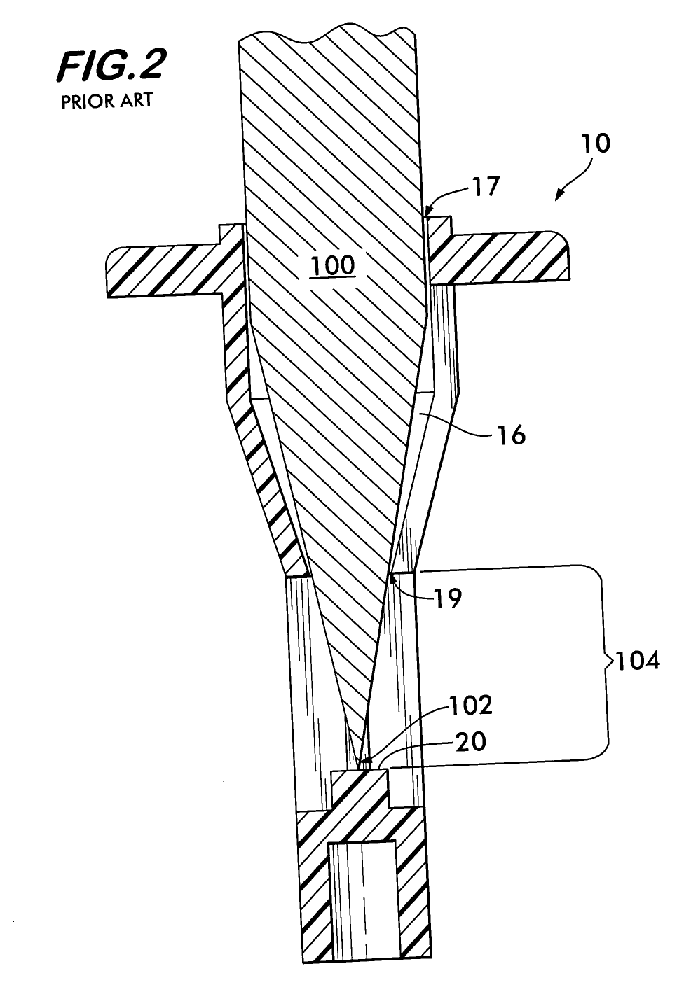

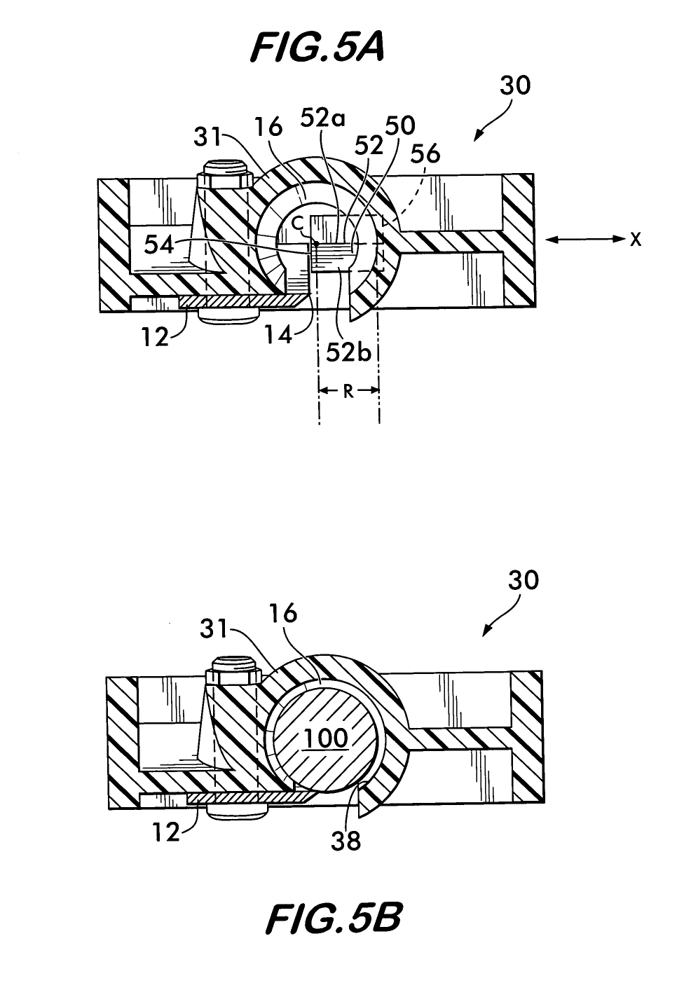

Like the exemplary blade carrier 10 of FIGS. 1 and 2, the subject blade carrier 30 of FIGS. 3-5B includes a body 31 having an insertion bore 16 adapted to receive a writing instrument 100. The insertion bore 16 has a broad outer end 17, a narrower inner end 19, and a longitudinal axis C. In the embodiment shown, the insertion bore 16 includes a first portion 16a adjacent the outer end 17, and a second portion 16b adjacent the inner end 19. In this embodiment, the first portion 16a has a generally cylindrical sidewall 36, and the second portion 16b has a generally conical sidewall 38. The second portion 16b of the insertion bore 16a has a radius R adjacent its inner end 19 (see FIGS. 3 and 5A). The body 31 supports a razor-type first cutting blade 12, which may be made of stainless steel or other suitable material. The blade 12 has a sharp edge 14 capable of cutting a writing instrument and is fastened to the carrier body 31 by a bolt, screw, etc. inserted through through-hole 13, as known in the art. The insertion bore 16 receives an end of a writing instrument 100 such that it will be sharpened by the first cutting blade 12 when the writing instrument 100 is rotated relative to, and moves into, the blade carrier 30. More particularly, one or more portions of the sidewalls 36, 38 act as a guide and/or brace to push and/or support the writing instrument against the blade 12 in position for cutting.

Accordingly, the first cutting blade 12 is operatively positioned with respect to the insertion bore 16 for sharpening a writing instrument in the longitudinal direction of the insertion bore 16, i.e. to longitudinally taper the writing instrument to create a generally conical tip, as known in the art.

The blade carrier 30 includes a second cutting blade 50 supported on the body 31 (see FIGS. 3, 4 and 5A). Preferably, the second cutting blade 50 is integrally formed as part of the body 31, e.g. by injection molding the body 31 to include structure forming the cutting blade 50 (see FIGS. 3, 4 and 5A), or by molding the body 31 around a discrete cutting blade 50 (not shown) by an insert molding process. For example, the body 31 and/or cutting blade 50 may be formed of a plastic, such as a polycarbonate plastic, or other material.

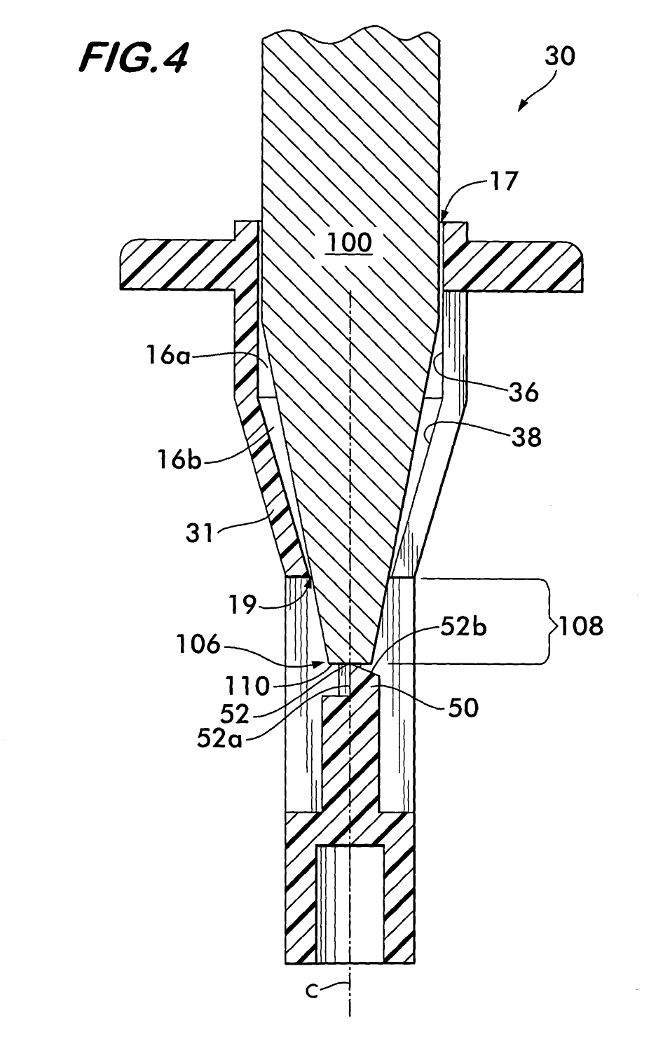

The cutting blade 50 has a cutting edge 52 that is sharp in that it forms a chisel-shaped tip having adjacent sides 52a, 52b, e.g. substantially planar surfaces, disposed relative to one another at an angle less than approximately ninety (90) degrees, e.g. in the range of 5 degrees to 85 degrees, or at any angle therebetween, as best shown in FIGS. 4 and 5A. The cutting edge 52 is operatively positioned with respect to the insertion bore 16 for cutting the writing instrument. More specifically, the cutting edge 52 is positioned to extend in a direction X that is transverse to the longitudinal direction Y of the insertion bore 16 (see FIGS. 3 and 5A). Accordingly, the cutting edge 52 extends in an X direction that is transverse to the sharp edge 14 of the first cutting blade 12, which extends in a Y direction (see FIG. 3). In this manner, the cutting edge 52 is positioned for cutting a distal end 106 of the writing instrument 100 to provide a generally frusto-conical tip 108 on the writing instrument 100. Preferably, the cutting edge 52 is positioned to intersect the longitudinal axis C, as shown in FIGS. 3, 4 and 5A. In this manner, the cutting edge may be positioned to cut the entire distal tip 110 of the writing instrument 100 (see FIG. 4).

As best shown in FIGS. 3 and 5A, the cutting edge 52 of the second cutting blade 50 has a first end 54 and a second end 56 opposite the first end 54. The first end 54 is positioned on one side of the axis C, and the second end 56 is positioned on the other side of the axis C, preferably at a distance from axis C no less than the radius (R) of the inner end 19 of the conical insertion bore 16, as shown in FIGS. 3 and 5A. This helps ensure that the entire distal tip 110 of the writing instrument 100 will be acted upon by the cutting edge 52.

In one embodiment, the cutting edge 52 is positioned to extend substantially perpendicularly to the central axis C of the conical insertion bore 16, i.e. so that angle a is ninety (90) degrees, as best shown in FIG. 3. This creates a flat distal tip 110 that is perpendicular to the central axis C. Alternatively, the cutting edge 52 may be positioned at an acute angle to the central axis C, such as at angles of about 45 degrees, about 70 degrees, in the range of about 45-70 degrees, or in the range of about 70-85 degrees.

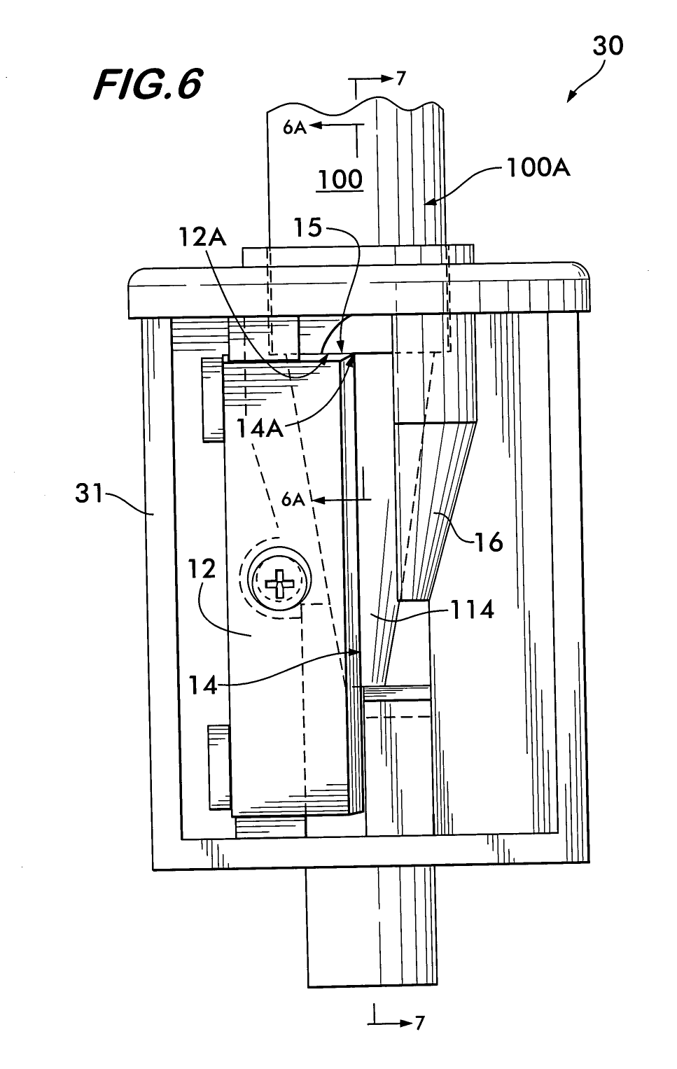

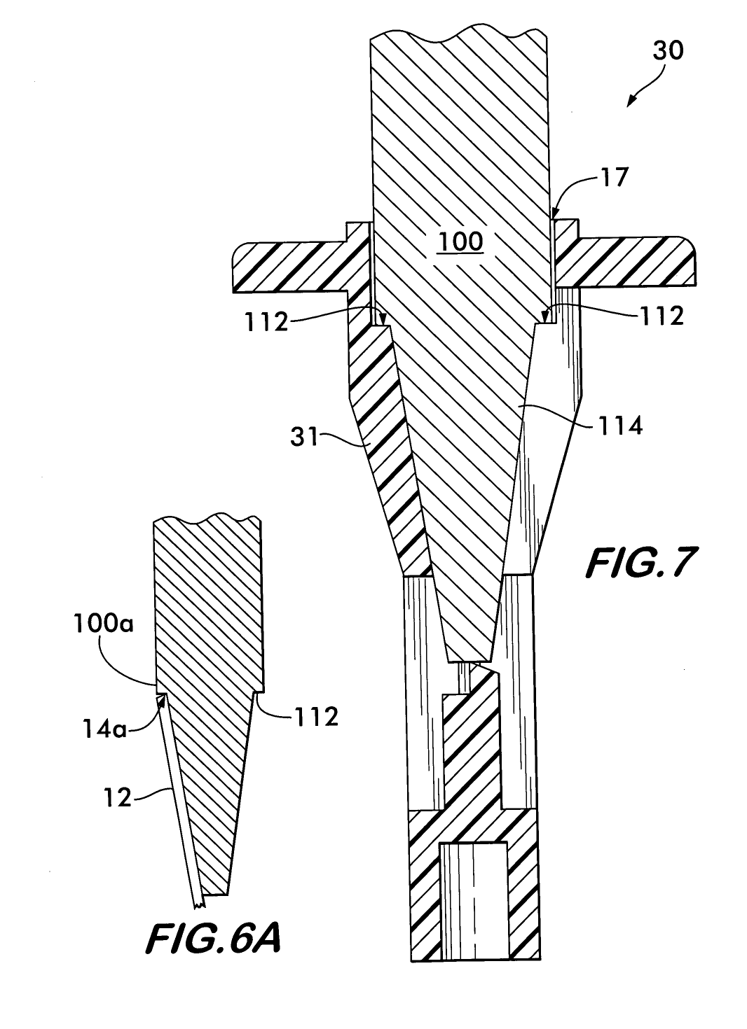

Referring now to FIGS. 6, 6A and 7, an alternative embodiment of the blade carrier 30 is shown. The blade carrier of FIGS. 6, 6A and 7 is similar to that of FIGS. 3-5B, except that the blade 12 is positioned on the body 31 such that the cutting edge 14 at one of its ends 15 is positioned to cut inwardly of the writing instrument 100 relative to the outer surface 100a of the writing instrument 100, as best shown in FIG. 6A. Referring now to FIG. 6A, this involves positioning the corner 14a of the cutting edge 14 further inwardly relative to the axis C of the writing instrument 100/insertion bore 16 (not shown). In this manner, the cutting blade 12 is operatively positioned on the body 31 for cutting the writing instrument 100 to provide an annular undercut 112 encircling a longitudinally tapered portion 114 of the writing instrument, as best shown in FIGS. 6A and 7. It is noted that the undercut 112 is further formed by a top edge 12a of the blade 12 (as shown in FIG. 6) as the writing instrument 100 is rotated, to provide the shape shown in FIGS. 6A and 7. Alternatively, the blade 12 and cutting edge 14, may extend radially (e.g. in the plane of the page in FIG. 6A) (not shown) at its upper end 15 to form the undercut 112. Preferably, the undercut 112 is formed immediately adjacent a full-diameter/full-perimeter portion of the writing instrument, between such portion and the longitudinally tapered portion 114, as shown in FIGS. 6, 6A and 7. This gives the overall tip of the writing instrument a frusto-conical configuration as well as a stepped configuration, which provides an appearance similar to that of a new crayon.

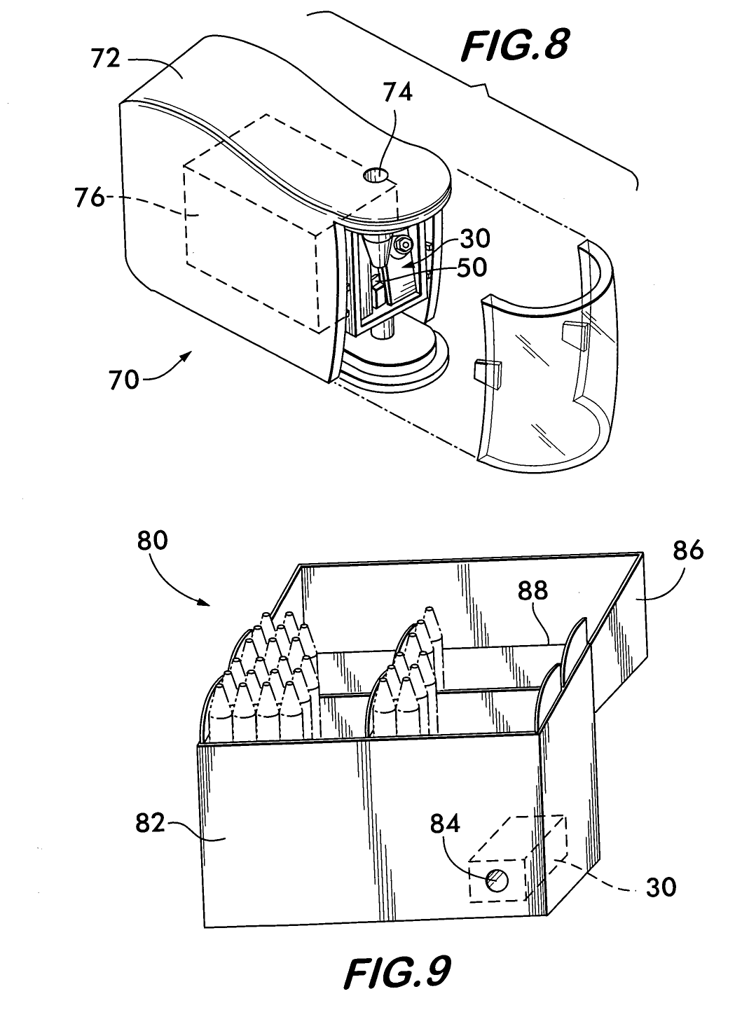

FIG. 8 shows a sharpener 70 for sharpening a writing instrument, such as a crayon. As shown in FIG. 8, the sharpener 70 includes a housing 72 defining an opening 74 adapted for receiving the writing instrument. The sharpener 70 also includes a blade carrier 30 (as described above with reference to FIGS. 3-5B or FIGS. 6 and 7) supported on the housing 70 for rotational motion relative thereto. The sharpener 70 further includes a drive mechanism 76 that is activatable to cause rotation of the blade carrier 30 to sharpen a writing instrument received in the insertion bore 16 through opening 74 of the housing 70. Such a drive mechanism 76 is shown in block/schematic form in FIG. 8 for simplicity; any suitable drive mechanism known in the art may be used. By way of example, the drive mechanism 76 may include a switch-operated battery- or other electric-powered motor, suitable gear train, etc. for causing rotation of the blade carrier 30, e.g. upon insertion of a writing instrument into the sharpener 70. Alternatively, the drive mechanism 76 may include a manually rotatable lever of a type known for conventional pencil sharpeners, such that rotation of the lever rotates the blade carrier 30 to sharpen a writing instrument. This can be achieved, for example, by modifying existing manual or powered sharpeners including a conventional blade carrier similar to that shown in FIGS. 1 and 2 to include a blade carrier 30 in accordance with the present invention.

FIG. 9 shows a container 80 for holding a plurality of writing instruments, e.g. sixty-four (64) crayons. The container 80 includes an exterior shell 82 having an opening 84 and a lid 86 pivotably mounted by a living hinge 88. Similar cardboard and/or paperboard boxes for writing instruments are known in the art. A blade carrier 30 in accordance with the present invention, e.g. the blade carrier 30 of FIGS. 3-5B or FIGS. 6 and 7, is mounted in the container 80 with the outer end 17 of the insertion bore 16 adjacent to and aligned with the opening 84 for receiving a crayon or other writing instrument inserted therethrough. In this manner, the blade carrier 30 is supported in and carried with the container 80, and may be used to sharpen the writing instruments carried therein.

Accordingly, a blade carrier and a pencil sharpener including such a blade carrier, are provided that can cut/sharpen a writing instrument both in a longitudinal direction (to provide a generally conical shape) and in a direction transverse to the longitudinal direction (to provide a broad point), i.e. for creating an overall frusto-conical tip on a writing instrument.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A blade carrier for sharpening a writing instrument, said blade carrier comprising:
a body having an insertion bore adapted to receive a writing instrument, said insertion bore having a longitudinal axis;
a first cutting blade supported on said body and operatively positioned with respect to said insertion bore for tapering the writing instrument in the longitudinal direction of said insertion bore; and
a second cutting blade supported on said body and operatively positioned with respect to said insertion bore for cutting the writing instrument in a direction transverse to the longitudinal direction of said insertion bore.

2. The blade carrier of claim 1, wherein said second cutting blade is operatively positioned for cutting the writing instrument in a direction perpendicular to the longitudinal direction of said insertion bore.

3. The blade carrier of claim 1, wherein said second cutting blade is operatively positioned for cutting the writing instrument in a direction forming an acute angle with the longitudinal direction of said insertion bore.

4. The blade carrier of claim 3, wherein said acute angle comprises an angle in the range of about 70-85 degrees.

5. The blade carrier of claim 1, wherein said insertion bore comprises a portion having a substantially conical sidewall.

6. The blade carrier of claim 1, wherein said second cutting blade is integrally formed with said body.

7. The blade carrier of claim 1, wherein said second cutting blade comprises a cutting edge positioned to intersect said longitudinal axis.

8. The blade carrier of claim 7, wherein said cutting edge of said second cutting blade is defined by the intersection of adjacent planar surfaces of said body.

9. The blade carrier of claim 8, wherein said adjacent planar surfaces intersect at an angle less than approximately ninety degrees.

10. The blade carrier of claim 1, wherein said second cutting blade comprises a cutting edge defined by the intersection of adjacent planar surfaces.

11. The blade carrier of claim 10, wherein said adjacent planar surfaces intersect at an angle less than approximately ninety degrees.

12. The blade carrier of claim 1, wherein said second cutting blade has a first end and a second end opposite said first end, said first end being positioned on one side of said longitudinal axis, said second end being positioned on a second side of said longitudinal axis opposite said first side.

13. The blade carrier of claim 12, wherein an inner end of said insertion bore has a radius R, and wherein said second end of said second cutting blade is positioned on said second side of said longitudinal axis at a distance no less than R from said longitudinal axis.

14. The blade carrier of claim 1, wherein said first cutting blade is operatively positioned on said body for cutting the writing instrument to provide an annular undercut encircling a longitudinally tapered portion of the writing instrument.

15. A blade carrier for sharpening a writing instrument, said blade carrier comprising:
a body having an insertion bore adapted to receive a writing instrument, said insertion bore having a longitudinal axis;
a first cutting blade supported on said body and operatively positioned with respect to said insertion bore for tapering the writing instrument in the longitudinal direction of said insertion bore; and
a second cutting blade supported on said body and operatively positioned with respect to said insertion bore for cutting the writing instrument in a direction substantially perpendicular to the longitudinal direction of said insertion bore.

16. The blade carrier of claim 15, wherein said second cutting blade comprises a cutting edge that is substantially straight.

17. The blade carrier of claim 16, wherein said second cutting edge is positioned to intersect said longitudinal axis.

18. The blade carrier of claim 15, wherein said second cutting blade is integrally formed with said body.

19. The blade carrier of claim 18, wherein said second cutting blade comprises a cutting edge that is defined by the intersection of adjacent planar surfaces of said body.

20. The blade carrier of claim 19, wherein said adjacent planar surfaces intersect at an angle less than approximately ninety degrees.

21. The blade carrier of claim 15, wherein said second cutting blade comprises a cutting edge that is defined by the intersection of adjacent planar surfaces.

22. The blade carrier of claim 21, wherein said adjacent planar surfaces intersect at an angle less than approximately ninety degrees.

23. The blade carrier of claim 15, wherein said second cutting blade has a first end and a second end opposite said first end, said first end being positioned on one side of said longitudinal axis, said second end being positioned on a second side of said longitudinal axis opposite said first side.

24. The blade carrier of claim 23, wherein an inner end of said insertion bore has a radius R, and wherein said second end is positioned on said second side of said longitudinal axis at a distance no less than R from said longitudinal axis.

25. The blade carrier of claim 15, wherein said first cutting blade is operatively positioned on said body for cutting the writing instrument to provide an annular undercut encircling a longitudinally tapered portion of the writing instrument.

26. A sharpener for sharpening a writing instrument, said sharpener comprising:
a housing defining an opening for receiving the writing instrument;
a blade carrier supported on said housing for rotational motion relative thereto, said blade carrier comprising:
a body having a tapered insertion bore adapted to receive a writing instrument, said insertion bore having a longitudinal axis, said insertion bore being aligned with said opening;
a first cutting blade supported on said body and operatively positioned with respect to said insertion bore for tapering the writing instrument in the longitudinal direction of said insertion bore; and
a second cutting blade supported on said body and operatively positioned with respect to said insertion bore for cutting the writing instrument in a direction transverse to the longitudinal direction of said insertion bore; and
a drive mechanism activatable to cause rotation of said blade carrier to sharpen a writing instrument received in said insertion bore.

27. The sharpener of claim 26, wherein said first cutting blade is operatively positioned on said body for cutting the writing instrument to provide an annular undercut encircling a longitudinally tapered portion of the writing instrument.

28. A container for carrying writing instruments, said container comprising:
a shell defining an opening for receiving the writing instrument;
a blade carrier supported on said shell, said blade carrier comprising:
a body having an insertion bore adapted to receive a writing instrument, said insertion bore having a longitudinal axis, said insertion bore being aligned with said opening;
a first cutting blade supported on said body and operatively positioned with respect to said insertion bore for tapering the writing instrument in the longitudinal direction of said insertion bore; and
a second cutting blade supported on said body and operatively positioned with respect to said insertion bore for cutting the writing instrument in a direction transverse to the longitudinal direction of said insertion bore.

29. The container of claim 28, wherein said first cutting blade is operatively positioned on said body for cutting the writing instrument to provide an annular undercut encircling a longitudinally tapered portion of the writing instrument.

30. A method for sharpening a writing instrument comprising:
inserting a portion of the writing instrument into a body having an insertion bore adapted to receive the writing instrument, said insertion bore having a longitudinal axis; and
rotating the writing instrument relative to the body to cause a first cutting blade to taper the writing instrument in the longitudinal direction of said insertion bore, and to cause a second cutting blade to cut an end of the writing instrument in a direction transverse to the longitudinal direction of said insertion bore.

31. The method of claim 30, wherein the writing instrument comprises a crayon.

32. The method of claim 30, wherein rotating the writing instrument further causes the first cutting blade to cut the writing instrument to provide an annular undercut encircling a longitudinally tapered portion of the writing instrument.

33. A blade carrier for sharpening a writing instrument, said blade carrier comprising:
a body having an insertion bore adapted to receive a writing instrument, said insertion bore having a longitudinal axis;
a first cutting blade supported on said body and operatively positioned with respect to said insertion bore for tapering the writing instrument in the longitudinal direction of said insertion bore, said first cutting blade being operatively positioned on said body for cutting the writing instrument to provide an annular undercut encircling a longitudinally tapered portion of the writing instrument.
